(19) United States
(12) Patent Application Publication
(10) Pub. No.: US 2026/0361399 A1
(43) Pub. Date: Nov. 12, 2026

(54) COMMUNICATION METHOD AND COMMUNICATION APPARATUSCROSS-REFERENCE TO RELATED APPLICATIONS

(71) Applicant: HUAWEI TECHNOLOGIES CO., LTD., Shenzhen (CN)

(72) Inventors: Ying Chen, Hangzhou (CN); Jingwei Zhang, Hangzhou (CN); Jiayin Zhang, Shanghai (CN); Jun Wang, Hangzhou (CN)

(73) Assignee: HUAWEI TECHNOLOGIES CO., LTD., Shenzhen (CN)

(21) Appl. No.: 19/726,859

(22) Filed: Jun. 30, 2026

Related U.S. Application Data
(63) Continuation of application No. PCT/CN2024/142616, filed on Dec. 26, 2024.

(30) Foreign Application Priority Data
Jan. 4, 2024 (CN) 202410027089.4

(51) Int. Cl. H04B 7/185

(52) U.S. Cl. CPC H04B 7/18547; H04B 7/18539; H04B 7/18589

(57) ABSTRACT

A communication method and a communication apparatus are provided, relating to the field of satellite communication technologies. In the method, a network device sends, to a terminal device, first information that indicates satellite information of at least two areas, where the at least two areas include a target area of the terminal device. The terminal device may determine satellite information of the target area based on the first information, and may determine, based on the satellite information of the target area, a policy for re-searching for a satellite network.

### CROSS-REFERENCE TO RELATED APPLICATIONS

application is a continuation of International Application No. PCT/CN2024/142616, filed on Dec. 26, 2024, which claims priority to Chinese Patent Application No. 202410027089.4, filed on Jan. 4, 2024. The disclosures of the aforementioned applications are hereby incorporated by reference in their entireties.

### TECHNICAL FIELD

This disclosure relates to the field of satellite communication technologies, and more specifically, to a communication method and a communication apparatus.

### BACKGROUND

Compared with a terrestrial network, a satellite network has unique advantages. For example, a satellite network can provide a wider coverage range, can provide communication services for areas that cannot be covered by the terrestrial network, such as oceans or forests; and for another example, and is less susceptible to natural disasters or external forces.

In a satellite communication scenario, a satellite can provide communication services for a terminal device. Because a satellite does not remain at a fixed location for an extended period, after the terminal device moves to a new location, the terminal device may need to re-search for a satellite network, to resume a connection to the satellite network or establish a connection to a new satellite network. In this process, overall power consumption of the terminal device during satellite network re-searching may be high. Therefore, how to reduce the overall power consumption of the terminal device during satellite network re-searching is an urgent technical problem to be resolved currently.

### SUMMARY

This disclosure provides a communication method and a communication apparatus, to help reduce overall power consumption of a terminal device during satellite network re-searching.

According to a first aspect, a communication method is provided, and includes: receiving first information, where the first information indicates satellite information of at least two areas, and the at least two areas include a target area of a terminal device; and determining satellite information of the target area based on the first information.

An execution body of the solution according to the first aspect may be the terminal device, or may be a module (for example, a chip system) of the terminal device, or may be a logical node, a logical module, or software that can implement all or some functions of the terminal device. This is not limited. For ease of description, the following uses the terminal device as an example for description.

In the foregoing solution, the terminal device may obtain the first information from a network device, where the first information indicates the satellite information of the at least two areas, or the first information indicates the satellite information corresponding to the at least two areas; and the at least two areas include the target area of the terminal device, or the target area of the terminal device is one or more of the at least two areas. The terminal device may determine satellite information of the target area based on the first information. After moving to the target area, the terminal device may perform corresponding satellite communication based on the satellite information of the target area.

Compared with a solution in which the terminal device searches for a satellite network extensively after moving to the target area, the foregoing solution can support the terminal device in re-searching for a satellite network in a targeted manner based on the obtained satellite information of the target area. For example, the satellite information of the target area indicates that the target area is always within a coverage range of a satellite, and the terminal device can perform smooth access to the satellite network. For another example, the satellite information of the target area indicates that a satellite corresponding to the target area appears in a period of time, and the terminal device may re-search for a satellite network in the period of time. This can effectively reduce overall power consumption of the terminal device during satellite network re-searching, in addition to achieving other technical effects.

In conclusion, satellite information of at least two areas is indicated, so that the terminal device can determine satellite information of a target area based on the satellite information of the at least two areas, and can re-search for a satellite network based on the satellite information of the target area. In this way, the overall power consumption of the terminal device during satellite network re-searching can be effectively reduced.

According to the first aspect, the method further includes: performing satellite communication based on the satellite information of the target area.

After moving to the target area, the terminal device may re-search for the satellite network based on the satellite information of the target area, and perform satellite communication based on the satellite network obtained through re-search, so that a satellite communication requirement of the terminal device can be met.

According to the first aspect, the method further includes: receiving second information, where the second information indicates to activate a first transmission configuration indicator state in a transmission configuration indicator state set, each transmission configuration indicator state in the transmission configuration indicator state set is associated with one piece of satellite information, and the first transmission configuration indicator state is associated with the target area; and activating the first transmission configuration indicator state based on the second information.

A transmission configuration indicator state is associated with satellite information, and when the terminal device needs to perform satellite device switching, the terminal device may implement switching between satellite devices based on switching between transmission configuration indicator states, so that signaling indication overheads can be effectively reduced. For example, if the transmission configuration indicator state is not associated with the satellite information, after the terminal device switches to a new satellite device, the terminal device needs to perform signaling exchange with the new satellite device, to access the new satellite device. After the transmission configuration indicator state is associated with the satellite information, the network device only needs to send the second information to the terminal device, and does not need to send other signaling to the terminal device. The terminal device switches to a new transmission configuration indicator state based on the indication of the second information. In this way, signaling exchange overheads during satellite device switching can be effectively reduced.

After the terminal device moves to the target area, the network device may indicate the terminal device to activate the first transmission configuration indicator state corresponding to the target area. After the terminal device activates the first transmission configuration indicator state based on the indication of the network device, the terminal device may perform satellite communication based on satellite information corresponding to the first transmission configuration indicator state.

According to the first aspect, the method further includes: performing uplink synchronization based on the satellite information associated with the first transmission configuration indicator state.

In this way, uplink synchronization between the terminal device and the satellite network can be supported after the terminal device moves.

According to the first aspect, the method further includes: receiving third information, where the third information is used to configure the transmission configuration indicator state set.

After the network device configures or indicates, for the terminal device or to the terminal device, the transmission configuration indicator state set including at least two transmission configuration indicator states, the terminal device may activate the specified first transmission configuration indicator state from the transmission configuration indicator state set based on the indication of the network device.

According to a second aspect, a communication method is provided, and includes: determining first information, where the first information indicates the satellite information of the at least two areas, and the at least two areas include the target area of the terminal device; and sending the first information to the terminal device.

An execution body of the solution according to the second aspect may be a network device, or may be a module (for example, a chip system) of the network device, or may be a logical node, a logical module, or software that can implement all or some functions of the network device. This is not limited. For ease of description, the following uses the network device as an example for description.

In the foregoing solution, the network device may send first information to the terminal device, where the first information indicates the satellite information of the at least two areas, or the first information indicates the satellite information corresponding to the at least two areas; and the at least two areas include the target area of the terminal device, or the target area of the terminal device is one or more of the at least two areas. The terminal device may determine satellite information of the target area based on the first information. After moving to the target area, the terminal device may perform corresponding satellite communication based on the satellite information of the target area.

Compared with a solution in which the terminal device searches for a satellite network extensively after moving to the target area, the foregoing solution can support the terminal device in re-searching for a satellite network in a targeted manner based on the obtained satellite information of the target area. For example, the satellite information of the target area indicates that the target area is always within a coverage range of a satellite, and the terminal device does not need to consume much power to re-search for the satellite network. For another example, the satellite information of the target area indicates that a satellite corresponding to the target area appears in specified time, and the terminal device may re-search for the satellite network in the specified time. This can effectively reduce overall power consumption of the terminal device during satellite network re-searching, in addition to achieving other technical effects.

In conclusion, satellite information of at least two areas is indicated, so that the terminal device can determine satellite information of a target area based on the satellite information of the at least two areas, and can re-search for a satellite network based on the satellite information of the target area. In this way, the overall power consumption of the terminal device during satellite network re-searching can be effectively reduced.

According to the second aspect, the method further includes: sending second information, where the second information indicates to activate a first transmission configuration indicator state in a transmission configuration indicator state set, each transmission configuration indicator state in the transmission configuration indicator state set is associated with one piece of satellite information, and the first transmission configuration indicator state is associated with the target area.

A transmission configuration indicator state is associated with satellite information, and when the terminal device needs to perform satellite device switching, the terminal device may implement switching between satellite devices based on switching between transmission configuration indicator states, so that signaling indication overheads can be effectively reduced. For example, if the transmission configuration indicator state is not associated with the satellite information, after the terminal device switches to a new satellite device, the terminal device needs to perform signaling exchange with the new satellite device, to access the new satellite device. After the transmission configuration indicator state is associated with the satellite information, the network device only needs to send the second information to the terminal device, and does not need to send other signaling to the terminal device. The terminal device switches to a new transmission configuration indicator state based on the indication of the second information. In this way, signaling exchange overheads during satellite device switching can be effectively reduced.

According to the second aspect, the method further includes: sending third information, where the third information is used to configure the transmission configuration indicator state set.

After the network device configures or indicates, for the terminal device or to the terminal device, the transmission configuration indicator state set including at least two transmission configuration indicator states, the terminal device may activate the specified first transmission configuration indicator state from the transmission configuration indicator state set based on the indication of the network device.

With reference to the method according to any one of the first aspect and the second aspect, the at least two areas include one or more of a first area, a second area, and a third area. The first area is an area in which a satellite service is always receivable by the terminal device, the second area is an area in which a satellite service is receivable by the terminal device within first time, and the third area is an area in which a satellite service is not receivable by the terminal device.

Characteristics of different types of areas are determined, so that the terminal device can determine, based on the characteristics of the different types of areas, an appropriate policy for searching for a satellite network. For example, if the target area is the first area, the terminal device may smoothly find the satellite network. For another example, if the target area is the second area, the terminal device may search for the satellite network within the first time, to avoid a case in which the terminal device is always in a state of searching for the satellite network, thereby reducing overall power consumption of the terminal device. For still another example, if the target area is the third area, the terminal device does not need to search for the satellite network, thereby reducing overall power consumption of the terminal device.

With reference to the method according to any one of the first aspect or the second aspect, the satellite information includes at least one of the following: identifier information of a satellite, ephemeris information of the satellite, service time of the satellite, visibility time of the satellite, a coverage area of the satellite, or identifier information of an associated area.

The terminal device may determine, based on one or more of the foregoing parameters or content, an appropriate policy for re-searching for the satellite network, thereby helping reduce overall power consumption of the terminal device during satellite network re-searching.

With reference to the method according to any one of the first aspect or the second aspect, the second information includes at least one of the following: identifier information of the first transmission configuration indicator state, identifier information of the satellite information associated with the first transmission configuration indicator state, or identifier information of a satellite corresponding to the first transmission configuration indicator state.

In this way, the terminal device may determine, based on one or more of the foregoing items, a transmission configuration indicator state that needs to be activated.

With reference to the method according to any one of the first aspect or the second aspect, the second information further indicates to deactivate a second transmission configuration indicator state in the transmission configuration indicator state set.

In this way, the terminal device may deactivate the second transmission configuration indicator state, to avoid a case in which the terminal device continues to use or enable the second TCI state after activating the first TCI state, thereby reducing the overall power consumption of the terminal device.

According to a third aspect, a communication system is provided, and includes a terminal device and a network device. The network device is configured to determine first information, and is further configured to send the first information to the terminal device, where the first information indicates satellite information of at least two areas, and the at least two areas include a target area of the terminal device. The terminal device is configured to: receive the first information, and determine satellite information of the target area based on the first information.

The terminal device and the network device may be further respectively configured to perform the method in the first aspect and the method in the second aspect.

According to a fourth aspect, a communication apparatus is provided. The communication apparatus may be a terminal device, or may be a device, a module, or the like that is configured to perform a function of the terminal device.

In an optional implementation, the communication apparatus may include modules or units that are in one-to-one correspondence with the methods/operations/steps/actions described in the first aspect. Such a module or unit may be implemented by a hardware circuit, software, or a combination of a hardware circuit and software.

According to a fifth aspect, a communication apparatus is provided. The communication apparatus may be a network device, or may be a device, a module, or the like that is configured to perform a function of the network device.

In an optional implementation, the communication apparatus may include modules or units that are in one-to-one correspondence with the methods/operations/steps/actions described in the second aspect. Such a module or unit may be implemented by a hardware circuit, software, or a combination of a hardware circuit and software.

According to a sixth aspect, a communication apparatus is provided. The communication apparatus includes: a transceiver unit, configured to receive first information, where the first information indicates satellite information of at least two areas, and the at least two areas include a target area of a terminal device; and a processing unit, configured to determine satellite information of the target area based on the first information.

The communication apparatus may be further configured to perform the solution according to the method according to any one of the first aspect and the optional manners of the first aspect. Details are not described again.

According to a seventh aspect, a communication apparatus is provided. The communication apparatus includes: a processing unit, configured to determine first information, where the first information indicates satellite information of at least two areas, and the at least two areas include a target area of a terminal device; and a transceiver unit, configured to send the first information to the terminal device.

The communication apparatus may be further configured to perform the solution according to the method according to any one of the second aspect or the optional manners of the second aspect. Details are not described again.

According to an eighth aspect, a communication apparatus is provided, and includes a processor. The processor is configured to: execute a computer program or instructions, or use a logic circuit, to cause the communication apparatus to perform the method according to any one of the first aspect and the optional implementations of the first aspect, or to cause the communication apparatus to perform the method according to any one of the second aspect and the optional implementations of the second aspect.

In an optional implementation, the communication apparatus further includes a memory, and the memory is configured to store the computer program or the instructions.

In an optional implementation, the communication apparatus further includes a communication interface, configured to input and/or output a signal.

According to a ninth aspect, a communication apparatus is provided, and includes a logic circuit and an input/output interface. The input/output interface is configured to input and/or output a signal. The logic circuit is configured to perform the method according to any one of the first aspect and the optional implementations of the first aspect; or the logic circuit is configured to perform the method according to any one of the second aspect and the optional implementations of the second aspect.

According to a tenth aspect, a computer-readable storage medium is provided. The computer-readable storage medium stores a computer program or instructions. When the computer program or the instructions are run on a computer, the method according to any one of the first aspect and the optional implementations of the first aspect is performed, or the method according to any one of the second aspect and the optional implementations of the second aspect is performed.

According to an eleventh aspect, a computer program product is provided, and includes instructions. When the instructions are run on a computer, the method according to any one of the first aspect and the optional implementations of the first aspect is performed, or the method according to any one of the second aspect and the optional implementations of the second aspect is performed.

According to a twelfth aspect, a chip system is provided. The chip is connected to a memory; and the chip is configured to read and execute a software program stored in the memory, to perform the method according to any one of the first aspect or the optional manners of the first aspect, or to perform the method according to any one of the second aspect or the optional manners of the second aspect.

According to a thirteenth aspect, a chip system is provided. The chip system includes: a communication interface, configured to communicate with another apparatus; and a processor, configured to cause a communication device on which the chip system is installed to perform the method according to any one of the first aspect and the optional manners of the first aspect, or configured to cause a communication device on which the chip system is installed to perform the method according to any one of the second aspect and the optional manners of the second aspect.

According to a fourteenth aspect, a chip system is provided, and the chip system includes a processor, a memory, and an input/output port. The memory is configured to store a computer program, and the processor is configured to execute the computer program stored in the memory, to cause the processor to perform the method according to any one of the first aspect and the optional manners of the first aspect, or to cause the processor to perform the method according to any one of the second aspect and the optional manners of the second aspect.

According to a fifteenth aspect, a chip system is provided. The chip system is used in an electronic device, and the chip system includes one or more processors. The processor is configured to invoke computer instructions to cause the electronic device to perform the method according to any one of the first aspect or the optional manners of the first aspect; or the processor is configured to invoke computer instructions to cause the electronic device to perform the method according to any one of the second aspect or the optional manners of the second aspect.

For descriptions of beneficial effects of any one of the third aspect to the fifteenth aspect, refer to the descriptions of the beneficial effects of the first aspect and the second aspect.

### BRIEF DESCRIPTION OF DRAWINGS

FIG. 1 is a diagram of a communication system applicable to an embodiment of this disclosure;

FIG. 2 is a diagram of an disclosure scenario according to an embodiment of this disclosure;

FIG. 3 is a diagram of an interaction procedure of a communication method according to an embodiment of this disclosure;

FIG. 4 is a diagram of movement of a terminal device according to an embodiment of this disclosure;

FIG. 5 is a diagram of an interaction procedure of another communication method according to an embodiment of this disclosure;

FIG. 6 is a block diagram of a communication apparatus according to an embodiment of this disclosure; and

FIG. 7 is a block diagram of another communication apparatus according to an embodiment of this disclosure.

### DESCRIPTION OF EMBODIMENTS

The following describes the technical solutions of this disclosure with reference to the accompanying drawings.

For ease of understanding of embodiments of this disclosure, the following several descriptions are provided first.
1. Unless otherwise specified, “at least two or more” means two or more.
2. Unless otherwise stated or logically conflicted, terms and/or descriptions in different embodiments of this disclosure are consistent and may be mutually referenced, and technical features in different embodiments may be combined based on an internal logical relationship thereof, to form a new embodiment.
3. Various numbers in this disclosure are merely used for distinguishing for ease of description, and are not used to limit the protection scope of this disclosure. Sequence numbers in this disclosure do not mean an execution sequence, and the execution sequence of the processes should be determined based on functions and internal logic of the processes. For example, in this specification, the claims, and the accompanying drawings of this disclosure, the terms “first”, “second”, “third”, “fourth”, and other various term numerals (if exist) are intended to distinguish between similar objects, but do not necessarily indicate a specific order or sequence. Data used in such a way is interchangeable in appropriate circumstances, so that embodiments described herein can be implemented in an order other than the order illustrated or described herein.

In addition, any embodiment or design scheme described as an “example” or “for example” in this disclosure should not be construed as being more preferred or more advantageous than another embodiment or design scheme. Exactly, use of the term “example”, “for example”, or the like is intended to present a related concept in a specific manner for ease of understanding.
4. The terms “include”, “have”, and any variants thereof are intended to cover a non-exclusive inclusion. For example, a process, a method, a system, a product, or a device that includes a series of steps or units is not necessarily limited to the steps or units that are expressly listed, but may include another step or unit that is not expressly listed or that is inherent to the process, the method, the product, or the device.
5. In this disclosure, “indicating” may be understood as “enabling”, and “enabling” may include “directly enabling” and “indirectly enabling”. When a piece of information is described as enabling A, the information may directly enable A or indirectly enable A, but it does not necessarily indicate that the information carries A.

Information enabled by the information is referred to as to-be-enabled information. In a specific implementation process, the to-be-enabled information may be enabled in a plurality of manners, for example, but not limited to a manner in which the to-be-enabled information, such as the to-be-enabled information or an index of the to-be-enabled information, may be directly enabled. Alternatively, the to-be-enabled information may be indirectly enabled by enabling other information, and there is an association relationship between the other information and the to-be-enabled information. Alternatively, only a part of the to-be-enabled information may be enabled, and other parts of the to-be-enabled information are known or agreed in advance. For example, specific information may be enabled by using a sequence that is of all pieces of information and that is agreed in advance (for example, specified in a protocol), so that enabling overheads are reduced to some extent. In addition, a common part of all pieces of information may be identified and enabled in a unified manner, to reduce enabling overheads caused by separately enabling the same information.
6. In this disclosure, “pre-configuration” may include predefinition, for example, definition in a protocol. The “predefinition” may be implemented by prestoring, in a device (including, for example, network elements), corresponding code, a corresponding table, or other related information that may be used for indication. A specific implementation thereof is not limited in this disclosure.
7. “Storage” or “storing” in this disclosure may mean being stored in one or more memories. The one or more memories may be separately disposed, or may be integrated into an encoder, a decoder, a processor, or a communication apparatus. Alternatively, a part of the one or more memories may be separately disposed, and a part of the one or more memories are integrated into a decoder, a processor, or a communication apparatus. A type of the memory may be a storage medium in any form. This is not limited.
8. The “protocol” in this disclosure may be a standard protocol in the communication field, for example, may include a 4th generation (4G) network protocol, a 5th generation (5G) network protocol, an NR protocol, and a future communication network. This is not limited in this disclosure.
9. Arrows or blocks shown by dashed lines in diagrams of the accompanying drawings in this specification of this disclosure indicate optional steps or optional modules.
10. Unless otherwise specified, “/” represents an “or” relationship between associated objects. For example, A/B may represent A or B. “And/or” in this disclosure merely describes an association relationship of associated objects and indicates that three relationships may exist. For example, A and/or B may indicate the following three cases: Only A exists, both A and B exist, and only B exists, where A and B may be singular or plural.
11. In this disclosure, “indication” may include a direct indication, an indirect indication, an explicit indication, and an implicit indication. When a piece of indication information is described as indicating A, it may be understood that the indication information carries A, directly indicates A, or indirectly indicates A.

In this disclosure, information indicated by the indication information is referred to as to-be-indicated information. In a specific implementation process, the to-be-indicated information may be indicated in a plurality of manner, for example, but not limited to a manner in which the to-be-indicated information, for example, the to-be-indicated information or an index of the to-be-indicated information, may be directly indicated. Alternatively, the to-be-indicated information may be indirectly indicated by indicating other information, and there is an association relationship between the other information and the to-be-indicated information. Alternatively, only a part of the to-be-indicated information may be indicated, and other parts of the to-be-indicated information are known or agreed in advance. For example, specific information may be indicated by using a sequence that is of all pieces of information and that is agreed in advance (for example, specified in a protocol), so that indication overheads are reduced to some extent. In addition, the to-be-indicated information may be sent as a whole, or may be divided into a plurality of pieces of sub-information to be sent separately, where sending periodicities and/or sending occasions of these pieces of sub-information may be the same or different.
12. In this disclosure, “sending” and “receiving” indicate signal transmission directions. For example, “sending information to XX” may be understood as that a destination end of the information is XX, and may include direct sending through an air interface, or include indirect sending, through an air interface, by another unit or module. “Receiving information from YY” may be understood as that a source end of the information is YY, and may include direct receiving from YY through an air interface, or may include indirect receiving from YY, through an air interface, from another unit or module. The “sending” may alternatively be understood as “outputting” by a chip interface, and the “receiving” may alternatively be understood as “inputting” by the chip interface. In other words, the sending and receiving may be performed between devices, for example, between a network device and a terminal device; or may be performed inside a device, for example, sending or receiving is performed, through a bus, a trace, or an interface, between components, modules, chips, software modules, or hardware modules inside the device.

A communication system applicable to embodiments of this disclosure is first described.

The technical solutions provided in this disclosure may be applied to various communication systems, for example, a 5th generation (5G) or new radio (NR) system, a long term evolution (LTE) system, an LTE frequency division duplex (FDD) system, and an LTE time division duplex (TDD) system.

The technical solutions provided in this disclosure may be further applied to a future communication network.

The technical solutions provided in this disclosure may be further applied to device-to-device (D2D) communication, vehicle-to-everything (V2X) communication, machine-to-machine (M2M) communication, machine-type communication (MTC), an internet of things (IoT) communication system, or another communication system.

A terminal device in embodiments of this disclosure includes various devices having a wireless communication function, and the terminal device may be configured to connect persons, objects, machines, and the like. The terminal device may be widely used in various scenarios, for example, scenarios like cellular communication, D2D, V2X, end-to-end (P2P), M2M, MTC, IoT, virtual reality (VR), augmented reality (AR), industrial control, autonomous driving, telemedicine, a smart grid, smart home, smart office, smart wearables, smart transportation, a smart city, uncrewed aerial vehicles, robots, remote sensing, passive sensing, positioning, navigation and tracking, and autonomous delivery. The terminal device may be a terminal in any one of the foregoing scenarios, for example, an MTC terminal or an IoT terminal. The terminal device may be, in the 3rd generation partnership project (3GPP) standard, user equipment (UE), a terminal, a fixed device, a mobile station device or a mobile device, a subscriber unit, a handheld device, a vehicle-mounted device, a wearable device, a cellular phone, a smartphone, a SIP phone, a wireless data card, a personal digital assistant (PDA), a computer, a tablet computer, a notebook computer, a wireless modem, a handheld device, a laptop computer, a computer having a wireless transceiver function, a smart book, a vehicle, a satellite, a global positioning system (GPS) device, a target tracking device, an aircraft (for example, an uncrewed aerial vehicle, a helicopter, a multicopter, a quadcopter, an airplane), a ship, a remote control device, a smart home device, or an industrial device; or an apparatus built in the foregoing device (for example, a communication module, a modem, or a chip in the foregoing device); or another processing device connected to the wireless modem. For ease of description, the following uses an example in which the terminal device is a terminal or a UE for description.

In some scenarios, the terminal device may alternatively serve as a base station. For example, the terminal device may act as a scheduling entity, and the terminal device provides a sidelink (SL) signal between UEs in scenarios like V2X, D2D, P2P, or the like.

In embodiments of this disclosure, an apparatus for implementing a function of the terminal device may be a terminal device, or may be an apparatus that can support a terminal device in implementing the function, for example, a chip system or a chip, where the apparatus may be installed in the terminal device. In embodiments of this disclosure, the chip system may include a chip, or may include a chip and another discrete device.

A network device in embodiments of this disclosure may be a device for communicating with the terminal device, and the network device may also be referred to as an access network device or a radio access network device. For example, the network device may be a base station. The network device in embodiments of this disclosure may be a radio access network (RAN) node (or device) that connects the terminal device to a wireless network.

The base station may cover the following names in a broad sense, or may be replaced with the following names, for example, a NodeB (NodeB), an evolved NodeB (eNB), a next generation NodeB (gNB), a relay station, an access point, a transmission reception point (transmission reception point, TRP), a transmission point (TP), a primary station, a secondary station, a multi-standard radio (MSR) node, a home base station, a network controller, an access node, a wireless node, an access point (AP), a transmission node, a transceiver node, a baseband unit (BBU), a remote radio unit (RRU), an active antenna unit (AAU), a remote radio head (RRH), a central unit (CU), a distributed unit (DU), and a positioning node.

In different systems, the CU (or a CU-CP and a CU-UP), the DU, or an RU may also have different names, and a person skilled in the art may understand meanings thereof. For example, the access network device may be a network device in an open radio access network (ORAN) system or a module of the network device. In an ORAN system, the CU may also be referred to as an open (O)-CU, the DU may also be referred to as an O-DU, the CU-CP may also be referred to as an O-CU-CP, the CU-UP may also be referred to as an O-CU-UP, and the RU may also be referred to as an O-RU. Any one of the CU (or the CU-CP and the CU-UP), the DU, and the RU in this disclosure may be implemented by using a software module, a hardware module, or a combination of a software module and a hardware module.

The base station may be a macro base station, a micro base station, a relay node, a donor node, or the like, or a combination thereof. The base station may alternatively be a communication module, a modem, or a chip disposed in the foregoing device or apparatus.

The base station may alternatively be a mobile switching center, a device functioning as the base station in D2D, V2X, or M2M communication, a network-side device in a future communication network, a device functioning as the base station in a future communication system, or the like. The base station may support networks of a same access technology or different access technologies. A specific technology and a specific device form that are used by the network device are not limited in embodiments of this disclosure.

The base station may be fixed or movable. For example, a helicopter or an uncrewed aerial vehicle may be configured as a mobile base station, and one or more cells may move based on a location of the mobile base station. In another example, a helicopter or an uncrewed aerial vehicle may be configured as a device for communicating with another base station.

In embodiments of this disclosure, an apparatus configured to implement a function of the network device may be a network device, or may be an apparatus that can support the network device in implementing the function, for example, a chip system or a chip. The apparatus may be installed in the network device. In embodiments of this disclosure, the chip system may include a chip, or may include a chip and another discrete device.

The network device and the terminal device may be deployed on the land, including indoors or outdoors, or in a handheld or vehicle-mounted manner; or may be deployed on water; or may be deployed on an airplane, a balloon, or a satellite in the air. Scenarios in which the network device and the terminal device are located are not limited in embodiments of this disclosure.

First, a network architecture applicable to embodiments of this disclosure is briefly described.

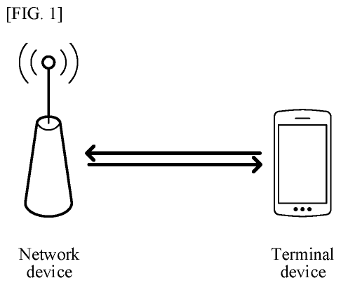

FIG. 1 is a diagram of a communication system applicable to an embodiment of this disclosure. As shown in FIG. 1, the communication system includes a network device and a terminal device. The network device may include a plurality of communication nodes. Each communication node may serve one physical cell, and is controlled by a control unit of the network device. A same terminal device performs communication in one physical cell at the same time.

The network device is an entity that sends or receives a signal, and is configured to communicate with the terminal device.

The terminal device is an entity that sends or receives a signal, and is configured to communicate with the network device.

In an optional application scenario, the network device and the terminal device shown in FIG. 1 may be used in a non-terrestrial network (NTN) scenario. An NTN system may include a satellite system. Based on satellite altitudes, namely, satellite orbit altitudes, satellite systems may be classified into a highly elliptical orbit (HEO) satellite, a geostationary earth orbit (GEO) satellite, a medium-earth orbit (MEO) satellite, and a low-earth orbit (LEO) satellite. In addition, the NTN system may further include an air network device, for example, a high altitude platform station (HAPS) communication system. The air network device in this disclosure is not limited to the foregoing examples.

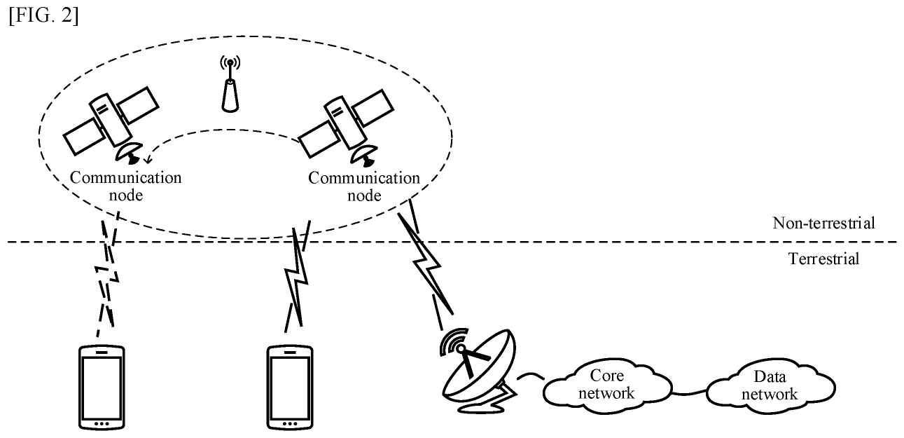

FIG. 2 is a diagram of an application scenario according to an embodiment of this disclosure. As shown in FIG. 2, a network device may be used as a base station for wireless communication, and a terrestrial station may forward signaling between the network device and a core network. At least one communication node is deployed on each satellite, and a plurality of communication nodes deployed on a plurality of satellites are controlled by a control unit of the network device. When a terminal device performs cell switching (for example, the cell switching is caused by a location change of the terminal device), the terminal device may directly switch from one communication node to another communication node without performing a procedure configured according to a radio resource control (RRC) protocol.

It should be noted that the communication systems described in embodiments of this disclosure are intended to describe the technical solutions of embodiments of this disclosure more clearly, but do not constitute a limitation on the technical solutions provided in embodiments of this disclosure. It can be learned by a person of ordinary skill in the art that the technical solutions provided in embodiments of this disclosure are also applicable to similar technical problems with the evolution of the network architecture and the emergence of a new service scenario.

Optionally, related functions of the terminal device and the network device in this disclosure may be implemented by one device, may be jointly implemented by a plurality of devices, may be implemented by one or more functional modules in one device, may be implemented by one or more chips, or may be implemented by a system on chip (SoC) or a chip system. The chip system may include a chip, or may include a chip and another discrete device. This is not specifically limited in embodiments of this disclosure.

It may be understood that the foregoing function may be a network element in a hardware device, or may be a software function run on dedicated hardware, or may be a combination of hardware and software, or may be a virtualization function instantiated on a platform.

In the scenario shown in FIG. 2, because the satellite does not stay at a location for a long time, after the terminal device moves to a new location, the terminal device may need to re-search for a satellite network, to resume a connection to the satellite network or establish a connection to a new satellite network. In the foregoing process, overall power consumption of the terminal device during satellite network re-searching may be high.

In view of this, this disclosure provides a communication method and a communication apparatus, to help reduce overall power consumption of a terminal device during satellite network re-searching.

The following describes the communication method and the communication apparatus in embodiments of this disclosure with reference to the accompanying drawings.

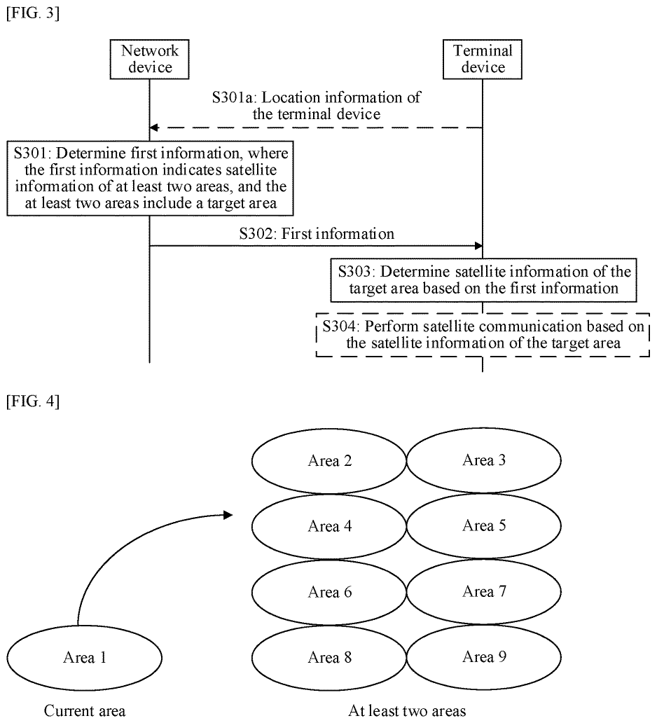

FIG. 3 is a diagram of an interaction procedure of a communication method according to an embodiment of this disclosure. The method shown in FIG. 3 may be performed by a network device and a terminal device, or may be performed by modules and/or devices (for example, chips or integrated circuits) that have corresponding functions and that are installed in the network device and the terminal device. This is not limited. The following uses the network device and the terminal device as an example for description. As shown in FIG. 3, the method includes the following steps.

Optionally, S301a: The terminal device sends location information of the terminal device to the network device.

Correspondingly, the network device receives the location information of the terminal device. The network device may provide a communication service for the terminal device.

S301: The network device determines first information.

The first information can indicate satellite information of at least two areas (or satellite information corresponding to the at least two areas). The satellite information of the at least two areas may be understood as that each of the at least two areas may have corresponding or associated satellite information. For the association between the area and the satellite information, refer to Table 1. Content described in Table 1 is merely used as an example, and is not used as a final limitation.

TABLE 1

| Area | Satellite information |
|---|---|
| Area a | Satellite information 1 |
| Area b | Satellite information 2 |
| Area c | Satellite information 3 |

As shown in Table 1:

The area is the area a, and is associated with or corresponds to the satellite information 1.

The area is the area b, and is associated with or corresponds to the satellite information 2.

The area is the area c, and is associated with or corresponds to the satellite information 3.

Satellite information corresponding to or associated with all areas may include same information or a same parameter. For example, there may be a same parameter between the satellite information 1 associated with the area a and the satellite information 2 associated with the area b. For example, a satellite corresponding to an area a is the same as a satellite corresponding to an area b (for example, the area a and the area b are two adjacent areas, and the area a and the area b may be within a coverage range of a same satellite) (that the satellite information is an identifier of the satellite is used as an example).

Satellite information corresponding to or associated with all areas may alternatively include different information or parameters. For example, there may be different parameters between the satellite information 1 associated with the area a and the satellite information 2 associated with the area b. For example, service time of a satellite corresponding to an area a is different from service time of a satellite corresponding to an area b. For example, service time of a satellite corresponding to the area a is 8:00 to 10:00, and service time of a satellite corresponding to the area b is 11:00 to 14:00 (that the satellite information is the service time of the satellite is used as an example) (the satellite corresponding to the area a and the satellite corresponding to the area b may be a same satellite, and this is not limited).

In conclusion, an area division manner is not limited in this embodiment of this disclosure, and division may be performed based on a coverage range of a satellite. For example, a coverage range of each satellite is referred to as one area. For example, a coverage range of a satellite 1 is referred to as the area a, and a coverage range of a satellite 2 is referred to as the area b. For another example, a coverage range of a satellite may be referred to as a plurality of areas. For example, a coverage range of a satellite 1 may include the area a, the area b, and the like. Alternatively, division may be performed based on service time of a satellite. For example, the area a is an area in which the service time of the satellite is 0:00 to 4:00 (a quantity of satellites is not limited), and the area b is an area in which the service time of the satellite is 4:00 to 8:00.

The at least two areas may be understood as areas to which the terminal device may move. Alternatively, the at least two areas include a target area of the terminal device. In other words, the target area of the terminal device may be one or more of the at least two areas. The target area of the terminal device may be understood as an area to which the terminal device finally moves.

In an optional implementation, the network device may determine the first information based on the location information of the terminal device.

For example, the location information of the terminal device indicates a current location of the terminal device. The network device may determine the current location of the terminal device based on the location information of the terminal device. The network device may estimate, based on the current location of the terminal device, an area range to which the terminal device may move. For example, the network device may consider a large range that is at a specific distance from the current location of the terminal device as the area range that the terminal device may reach. The network device may determine satellite information corresponding to or associated with the area range, or may determine satellite information corresponding to each small area in the area range. This is not limited. For example, the network device determines satellite information corresponding to a large area, may divide the large area into a plurality of small areas, and determines satellite information corresponding to each small area. For example, the satellite information is satellite service time. The network device determines that satellite service time corresponding to the large area is 8:00 to 19:00, and divides the large area into three small areas, and satellite service time corresponding to all the small areas is 8:00 to 12:00, 12:00 to 16:00, and 16:00 to 19:00 respectively.

For another example, the location information of the terminal device indicates an area range that the terminal device may reach. The network device may determine, based on the location information of the terminal device, the area range that the terminal device may reach. The network device may determine satellite information corresponding to or associated with the area range. For descriptions of determining, by the network device, the satellite information corresponding to or associated with the area range, refer to the foregoing descriptions. Details are not described again.

For still another example, the location information of the terminal device further indicates a movement trajectory of the terminal device. The network device may determine, based on the movement trajectory of the terminal device, an area range that the terminal device may reach. The network device may determine satellite information corresponding to or associated with the area range. For descriptions of determining, by the network device, the satellite information corresponding to or associated with the area range, refer to the foregoing descriptions. Details are not described again.

In conclusion, when the network device determines the first information based on the location information of the terminal device, the satellite information of the at least two areas that is indicated by the first information can meet a requirement of the terminal device. For example, the at least two areas may include the target area of the terminal device. The terminal device may determine satellite information of the target area based on the first information, and determine, based on the satellite information of the target area, a policy for re-searching for a satellite network, thereby effectively helping reduce overall power consumption of the terminal device during satellite network re-searching.

In another optional implementation, the network device may determine the first information independently of the location information of the terminal device.

For example, a movement trajectory of the terminal device may be pre-configured for the network device. The network device may determine, based on the pre-configured movement trajectory of the terminal device, an area range that the terminal device may reach, and may determine satellite information corresponding to the area range.

In conclusion, when the network device determines the first information independently of the location information of the terminal device, overheads of signaling exchange between the terminal device and the network device can be reduced. In conclusion, a specific manner in which the network device determines the first information is not limited in this embodiment of this disclosure.

In an optional implementation, the at least two areas include at least one of the following:
a first area,
a second area, or
a third area.

The first area may be an area in which a satellite service is always receivable by the terminal device. For example, when the target area of the terminal device is the first area, the terminal device may perform smooth access to the satellite network.

The second area may be an area in which a satellite service is receivable by the terminal device within first time (which may also be understood as first configuration time, first preset time, or the like, and may be represented by using another term, and this is not limited). For example, when the target area of the terminal device is the second area, the first time may be 10:00 to 18:00, and the terminal device re-searches for the satellite network within the first time. In this way, the terminal device may consume power within the first time to re-search for the satellite network, and does not need to continuously consume power throughout the day to re-search for the satellite network, so that overall power consumption of the terminal device during satellite network re-searching can be effectively reduced.

The third area may be an area in which a satellite service is not receivable by the terminal device. For example, when the target area of the terminal device is the third area, the terminal device does not need to re-search for the satellite network, to avoid an unnecessary process of re-searching for the satellite network by the terminal device.

In an optional implementation, the third area may be within a coverage range of a satellite. The satellite provides a satellite service only for a special device, and does not provide the satellite service for a common device. After the terminal device moves to the third area, a service of a satellite corresponding to the third area is not receivable by the terminal device. For example, the satellite information includes service time of a satellite. Service time of the satellite corresponding to the third area is 0. The terminal device may determine, based on this, that the service of the satellite corresponding to the third area is not receivable by the terminal device.

In another optional implementation, the third area may not be within a coverage range of a satellite. In other words, there is no satellite whose coverage range includes the third area. For example, the satellite information includes a coverage area of a satellite. A coverage range of a satellite corresponding to the third area is 0. In this way, the terminal device may determine, based on this, that a satellite service is not receivable by the terminal device when the terminal device is in the third area.

In conclusion, a specific representation form of the satellite information of the third area is not limited in this embodiment of this disclosure.

It should be noted that the first area may refer to one or more areas, the second area may also refer to one or more areas, and the third area may also refer to one or more areas. This is not limited.

Characteristics of different types of areas are determined, so that the terminal device can determine, based on the characteristics of the different types of areas, an appropriate policy for searching for a satellite network. For example, if the target area is the first area, the terminal device may smoothly find the satellite network. For another example, if the target area is the second area, the terminal device may search for the satellite network within the first time, to avoid a case in which the terminal device is always in a state of searching for the satellite network, thereby reducing overall power consumption of the terminal device. For still another example, if the target area is the third area, the terminal device does not need to search for the satellite network, thereby reducing overall power consumption of the terminal device.

In an optional implementation, the network device may indicate, to the terminal device, satellite information of at least two areas that do not include the third area. In this way, the terminal device may obtain, through screening, an area in which a satellite service is not receivable by the terminal device.

In another optional implementation, the network device may alternatively indicate, to the terminal device, satellite information of at least two areas that include the third area. In this way, the terminal device may obtain satellite information corresponding to each area.

In an optional implementation, the satellite information may include at least one of the following:
identifier information of a satellite,
ephemeris information of the satellite,
service time of the satellite,
visibility time of the satellite,
a coverage area of the satellite, or
identifier information of an associated area.

For example, the satellite information includes the identifier information of the satellite (which may include an identifier, an index, or the like of the satellite).

The network device may determine an identifier of a satellite corresponding to each of the at least two areas. In other words, the network device may determine a serving satellite corresponding to each of the at least two areas. The identifier information of the satellite is indicated, so that the terminal device can determine, in the at least two areas, a specific area in which a satellite may exist or that may be an area in which a satellite service is receivable. The terminal device may search for a satellite network in an area in which a satellite exists, and does not search for the satellite network in an area in which no satellite exists. This helps reduce overall overheads of searching for the satellite network by the terminal device.

For the third area, for example, the satellite information includes the identifier information of the satellite. Identifier information in the third area may be represented as 0. Based on this, the terminal device may determine that the satellite service is not receivable by the terminal device when the terminal device is in the third area.

For example, the satellite information includes the ephemeris information of the satellite.

The network device may determine ephemeris information of a satellite corresponding to each of the at least two areas. The ephemeris information of the satellite is indicated, so that the terminal device can determine, based on the ephemeris information of the satellite corresponding to each area, service time, visibility time, a coverage range, or the like of the satellite of each area. The terminal device may search for a satellite network within the service time, the visibility time, or the coverage range of the satellite, and does not search for the satellite network outside the service time, the visibility time, or the coverage range of the satellite. This helps reduce overall overheads of searching for the satellite network by the terminal device.

For the third area, for example, the satellite information includes the ephemeris information of the satellite. Ephemeris information in the third area may be represented as 0. Based on this, the terminal device may determine that the satellite service is not receivable by the terminal device when the terminal device is in the third area.

For example, the satellite information includes the service time of the satellite.

The network device may determine service time of a satellite corresponding to each of the at least two areas. The service time of the satellite is indicated, so that the terminal device can search for a satellite network within the service time of the satellite, and does not search for the satellite network outside the service time of the satellite. This helps reduce overall overheads of searching for the satellite network by the terminal device.

For the third area, for example, the satellite information includes the service time of the satellite. Service time in the third area may be represented as 0. Based on this, the terminal device may determine that the satellite service is not receivable by the terminal device when the terminal device is in the third area.

For example, the satellite information includes the visibility time of the satellite.

The network device may determine visibility time of a satellite corresponding to each of the at least two areas. The visibility time of the satellite is indicated, so that the terminal device can search for a satellite network within the visibility time of the satellite, and does not search for the satellite network outside the visibility time of the satellite. This helps reduce overall overheads of searching for the satellite network by the terminal device.

For the third area, for example, the satellite information includes the visibility time of the satellite. Visibility time in the third area may be represented as 0. Based on this, the terminal device may determine that the satellite service is not receivable by the terminal device when the terminal device is in the third area.

For example, the satellite information includes the coverage area of the satellite.

The network device may determine a coverage area of a satellite corresponding to each of the at least two areas. The coverage area of the satellite is indicated, so that the terminal device can search for a satellite network in the coverage area of the satellite, and does not search for the satellite network outside the coverage range of the satellite. This helps reduce overall overheads of searching for the satellite network by the terminal device.

For the third area, for example, the satellite information includes the coverage area of the satellite. A coverage area of a satellite corresponding to the third area may be represented as 0. Based on this, the terminal device may determine that the satellite service is not receivable by the terminal device when the terminal device is in the third area.

For example, the satellite information includes the identifier information of the associated area (which may include an identifier, an index, or the like of the area).

The identifier information of the associated area is indicated, so that the terminal device can determine satellite information corresponding to each area. In this way, the terminal device can determine, based on the satellite information corresponding to each area, an appropriate occasion for searching for a satellite network, searches for the satellite network on the appropriate occasion, and does not search for the satellite network outside the appropriate occasion. This helps reduce overall overheads of searching for the satellite network by the terminal device.

Satellites corresponding to all of the at least two areas may be the same or may not be the same. This is not limited. In conclusion, the terminal device may determine, based on one or more of the foregoing enumerated parameters or content in the satellite information, an appropriate policy for re-searching for the satellite network, thereby helping reduce overall power consumption of the terminal device during satellite network re-searching.

For descriptions of the satellite information, refer to Table 2 and Table 3. Content described in Table 2 and Table 3 is merely used as an example, and is not used as a final limitation.

TABLE 2

| | Satellite | |
|---|---|---|
| Area | identifier | Service time |
| First area | 11 | 0:00 to 24:00 |
| Second area | 22 | 8:00 to 18:00 |
| Third area | 33 | 0:00 to 0:00 |

As shown in Table 2:

The first area is associated with a satellite associated with the satellite identifier 11, and the service time of the satellite is 0:00 to 24:00.

The second area is associated with a satellite associated with the satellite identifier 22, and the service time of the satellite is 8:00 to 18:00.

The third area is associated with a satellite associated with the satellite identifier 33, and the service time of the satellite is 0:00 to 0:00.

In this way, the terminal device may determine, for each area based on satellite information of the first area, satellite information of the second area, and satellite information of the third area, a policy for searching for a satellite network.

TABLE 3

| | Satellite | |
|---|---|---|
| Area | identifier | Service time |
| First area | 11 | 0:00 to 24:00 |
| Second area | 22 | 8:00 to 18:00 |
| Third area | — | 0:00 to 0:00 |

As shown in Table 3:

The first area is associated with a satellite associated with the satellite identifier 11, and the service time of the satellite is 0:00 to 24:00.

The second area is associated with a satellite associated with the satellite identifier 22, and the service time of the satellite is 8:00 to 18:00.

The third area is not associated with a satellite, and service time of a satellite is 0:00 to 0:00.

In this way, the terminal device may determine, for each area based on satellite information of the first area, satellite information of the second area, and satellite information of the third area, a policy for searching for a satellite network.

In conclusion, for the satellite information of the third area, a representation form of the satellite information of the third area is not limited in this embodiment of this disclosure.

S302: The network device sends the first information to the terminal device.

Correspondingly, the terminal device receives the first information.

S303: The terminal device determines, based on the first information, the satellite information corresponding to the target area.

As mentioned above, the first information indicates the satellite information of the at least two areas. After obtaining the first information, the terminal device may determine, based on the satellite information that is indicated by the first information and that corresponds to the at least two areas, the satellite information corresponding to the target area.

In this embodiment of this disclosure, the terminal device may determine the target area in advance, and may determine, based on the first information, the satellite information corresponding to the target area. For example, the terminal device determines that the target area is the area a, and the first information indicates satellite information respectively corresponding to the area a and the area b. The terminal device may determine the satellite information of the target area (which is the area a) based on the first information.

In this embodiment of this disclosure, the terminal device may not determine the target area in advance, and determine the target area based on the first information.

For example, the at least two areas include the first area, and the terminal device may determine that the target area is the first area, and can obtain the satellite information corresponding to the first area.

For example, the at least two areas include the second area, and the terminal device may determine that the target area is the second area, and can obtain the satellite information corresponding to the second area.

For example, the at least two areas include the third area, and the terminal device may determine that the target area is the third area, and can obtain the satellite information corresponding to the third area (for example, identifier information of a satellite corresponding to the third area is 11 (which indicates a satellite), and service time of the satellite corresponding to the third area is 0 (which indicates that a satellite service cannot be provided)).

When the target area is the third area, the terminal device may further obtain and store the satellite information corresponding to the first area and/or the second area. When the terminal device needs to perform emergency communication, the terminal device may move to the first area and/or the second area, and may receive a satellite service based on the satellite information corresponding to the first area and/or the second area.

An example of a scenario in which the terminal device moves is described below with reference to FIG. 4.

FIG. 4 is a diagram of movement of a terminal device according to an embodiment of this disclosure. As shown in FIG. 4, a current location of the terminal device is an area 1, and the at least two areas include an area 2 to an area 9. The first information may indicate satellite information corresponding to or associated with each of the area 2 to the area 9. When the terminal device needs to move from the area 1, and the target area is any one of the area 2 to the area 9, the terminal device may determine, based on the satellite information corresponding to or associated with each of the area 2 to the area 9, that an area in the area 2 to the area 9 is the target area.

For example, the area 2 is the first area, and the terminal device may determine that the area 2 is the target area. In addition, after moving to the area 2, the terminal device may perform satellite communication based on satellite information corresponding to or associated with the area 2.

For example, the area 3 is the second area, and the terminal device may determine that the area 3 is the target area. In addition, after moving to the area 3, the terminal device may perform satellite communication based on satellite information corresponding to or associated with the area 3.

For example, the area 4 is the third area, and the terminal device may determine that the area 4 is the target area. In addition, after moving to the area 4, the terminal device may not re-search for a satellite network.

When the terminal device in the area 4 needs to perform emergency communication, the terminal device may move from the area 4 to the area 2 or the area 3, and may perform satellite communication based on the satellite information corresponding to or associated with the area 2 or the area 3.

With reference to the content shown in FIG. 4, it can be learned that after the terminal device obtains the first information, the terminal device may determine an appropriate target area based on the first information, may determine, based on satellite information corresponding to or associated with the target area, an appropriate occasion for re-searching for a satellite network, re-searches for the satellite network on the occasion, and does not re-search for the satellite network outside the occasion. This helps reduce overall power consumption of the terminal device during satellite network re-searching.

It should be noted that the content shown in FIG. 4 is that the terminal device determines the target area based on the first information, and obtains the satellite information of the target area. In this embodiment of this disclosure, the terminal device may be supported in determining the target area in advance. For example, the terminal device determines, in advance, that the target area is the area 2, and obtains the satellite information of the area 2 based on the first information. After moving from the area 1 to the area 2, the terminal device may determine, based on the satellite information of the area 2, a policy for re-searching for a satellite network.

In the foregoing solution, the terminal device may obtain the first information from the network device, where the first information indicates the satellite information of the at least two areas, or the first information indicates the satellite information corresponding to the at least two areas; and the at least two areas include the target area of the terminal device, or the target area of the terminal device is one or more of the at least two areas. The terminal device may determine the satellite information of the target area based on the first information. After moving to the target area, the terminal device may perform corresponding satellite communication based on the satellite information of the target area.

Compared with a solution in which the terminal device searches for a satellite network extensively after moving to the target area, the foregoing solution can support the terminal device in re-searching for a satellite network in a targeted manner based on the obtained satellite information of the target area. For example, the satellite information of the target area indicates that the target area is always within a coverage range of a satellite, and the terminal device does not need to consume much power to re-search for the satellite network. For another example, the satellite information of the target area indicates that a satellite corresponding to the target area appears in specified time, and the terminal device may re-search for the satellite network in the specified time. This can effectively reduce overall power consumption of the terminal device during satellite network re-searching, in addition to achieving other technical effects.

In conclusion, satellite information of at least two areas is indicated, so that the terminal device can determine satellite information of a target area based on the satellite information of the at least two areas, and can re-search for a satellite network based on the satellite information of the target area. In this way, the overall power consumption of the terminal device during satellite network re-searching can be effectively reduced.

Optionally, the method may further include the following step.

S304: The terminal device performs satellite communication based on the satellite information of the target area.

For example, when the target area is the first area, after obtaining the satellite information corresponding to the target area, the terminal device may re-search for a satellite network, and may access a satellite network obtained through re-search, to implement satellite communication.

For example, when the target area is the second area, after obtaining the satellite information corresponding to the target area, the terminal device may re-search for a satellite network within specified time, and may access a satellite network obtained through re-search, to implement satellite communication.

In this way, after a location of the terminal device changes, the terminal device can access the satellite network, to implement satellite communication.

In conclusion, after moving to the target area, the terminal device may re-search for the satellite network based on the satellite information of the target area, and perform satellite communication based on the satellite network obtained through re-search, so that a satellite communication requirement of the terminal device can be met.

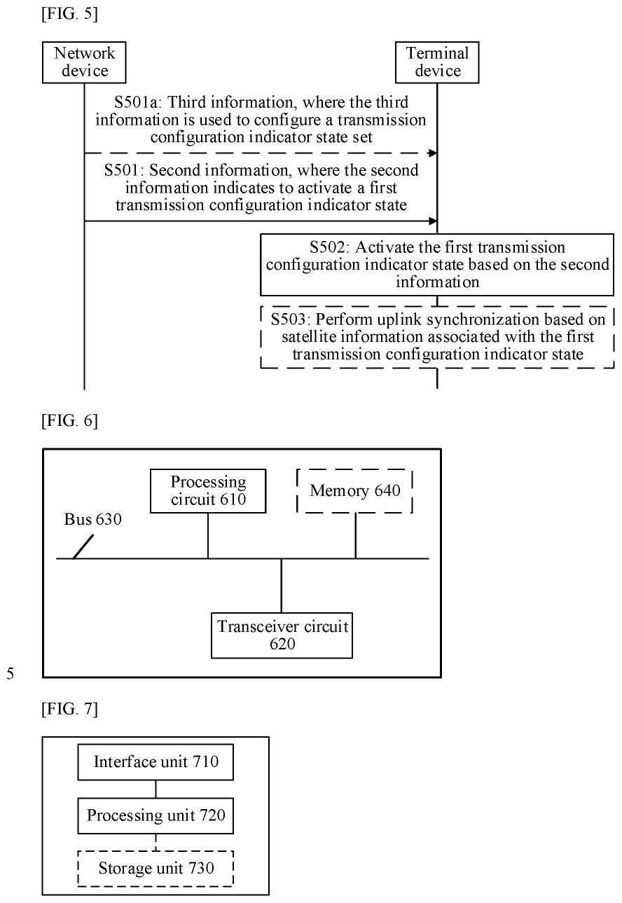

The method shown in FIG. 3 is described by using a scenario in which the terminal device performs satellite communication based on the satellite information of the target area as an example. The following describes, with reference to FIG. 5, a scenario in which the terminal device performs satellite switching.

It should be noted that the method described in FIG. 3 and a method described in FIG. 5 may be coupled together or independent of each other. For example, after moving to the target area, the terminal device may perform satellite switching; for another example, after performing satellite switching, the terminal device then moves to the target area; and so on.

FIG. 5 is a diagram of an interaction procedure of another communication method according to an embodiment of this disclosure. The method shown in FIG. 5 may be performed by a network device and a terminal device, or may be performed by modules and/or devices (for example, chips or integrated circuits) that have corresponding functions and that are installed in the network device and the terminal device. This is not limited. The following uses the network device and the terminal device as an example for description. As shown in FIG. 5, the method includes the following steps.

Optionally, S501a: The network device sends third information to the terminal device.

Correspondingly, the terminal device receives the third information.

The third information can be used to configure a transmission configuration indicator (TCI) state set, and the TCI state set includes at least two TCI states. For example, the TCI state set includes a first TCI state and a second TCI state. The first TCI state is a TCI state that needs to be activated by the terminal device, and the second TCI state is a TCI state that is being used by the terminal device.

After the network device configures or indicates, to the terminal device, the transmission configuration indicator state set including the at least two transmission configuration indicator states, the terminal device may activate a specified transmission configuration indicator state from the transmission configuration indicator state set based on the indication of the network device.

Optionally, the TCI state set may be configured. In this way, signaling overheads used to indicate the TCI state set can be reduced.

In this embodiment of this disclosure, each TCI state is associated with one piece of satellite information. For details, refer to Table 4. Content described in Table 4 is merely used as an example, and is not used as a final limitation.

TABLE 4

| TCI state | Satellite information |
|---|---|
| TCI state 1 | Satellite information 1 |
| TCI state 2 | Satellite information 2 |
| TCI state 3 | Satellite information 3 |

As shown in Table 4:

The TCI state is the TCI state 1, and is associated with or corresponds to the satellite information 1.

The TCI state is the TCI state 2, and is associated with or corresponds to the satellite information 2.

The TCI state is the TCI state 3, and is associated with or corresponds to the satellite information 3.

For descriptions of the satellite information, refer to the foregoing descriptions. Details are not described again.

Optionally, the first TCI state is associated with the foregoing target area.

For example, after the terminal device moves to the target area, the terminal device needs to perform satellite switching. For example, before a location of the terminal device changes, a satellite 1 provides a service for the terminal device, and after the terminal device moves to the target area, a satellite 2 provides a service for the terminal device. The terminal device needs to switch from the satellite 1 to the satellite 2. A TCI state is associated with a satellite, so that signaling overheads for the terminal device to perform satellite switching can be reduced.

S501: The network device sends second information to the terminal device.

Correspondingly, the terminal device receives the second information.

The second information indicates to activate the first TCI state in the TCI state set.

In this embodiment of this disclosure, after the terminal device moves to the target area, the network device may send the second information to the terminal device, where the second information indicates the terminal device to activate the first TCI state, and the first TCI state is associated with the target area.

In an optional implementation, after the terminal device moves to the target area, the network device may indicate the terminal device to activate the first TCI state corresponding to the target area. After the terminal device activates the first TCI state based on the indication of the network device, the terminal device may perform satellite communication based on satellite information corresponding to the first TCI state.

In an optional implementation, the second information may include at least one of the following:
identifier information of the first TCI state (which may include an identifier, an
index, or the like of the first TCI state);
identifier information of the satellite information associated with the first TCI state (which may include an identifier, an index, or the like of the satellite information); or
identifier information of a satellite corresponding to the first TCI state (which may include an identifier, an index, or the like of the satellite).

For example, the second information includes the identifier information of the first TCI state. The terminal device may determine the first TCI state from the TCI state set based on the identifier information of the first TCI state, and may activate the first TCI state.

For example, the second information includes the identifier information of the satellite information associated with the first TCI state. The terminal device may determine corresponding satellite information based on the identifier information of the associated satellite information, may determine, based on a correspondence between satellite information and a TCI state, the first TCI state corresponding to the satellite information, and may activate the first TCI state.

For example, the second information includes the identifier information of the satellite corresponding to the first TCI state. The terminal device may determine a corresponding satellite based on the identifier information of the corresponding satellite, may determine, based on a correspondence between a satellite and a TCI state, the first TCI state corresponding to the satellite, and may activate the first TCI state.

In this way, the terminal device may activate the first TCI state based on one or more of the foregoing items.

In conclusion, the terminal device may determine, based on one or more of the foregoing items, a TCI state that needs to be activated.

S502: The terminal device activates the first TCI state based on the second information.

Specifically, the terminal device may activate the first TCI state based on the foregoing descriptions of the second information.

In conclusion, a TCI state is associated with satellite information, so that when the terminal device needs to perform satellite device switching, the terminal device may implement, based on switching between TCI states, switching between satellite devices. This can effectively reduce signaling indication overheads. For example, if the TCI state is not associated with the satellite information, after the terminal device switches to a new satellite device, the terminal device needs to perform signaling exchange with the new satellite device, to access the new satellite device. After the TCI state is associated with the satellite information, the network device only needs to send the second information to the terminal device, and does not need to send other signaling to the terminal device. The terminal device switches to a new TCI state based on the indication of the second information. In this way, signaling exchange overheads during satellite device switching can be effectively reduced.

Optionally, the method may further include the following step.

S503: The terminal device performs uplink synchronization based on the satellite information associated with the first TCI state.

After the terminal device activates the first TCI state, the terminal device may perform uplink synchronization based on the satellite information associated with the first TCI state.

The first TCI state is associated with the target area. In this way, uplink synchronization between the terminal device and a satellite network can be supported after the terminal device moves.

In an optional implementation, the second information may further indicate to deactivate the second TCI state in the TCI state set. In this way, the terminal device may deactivate the second TCI state, to avoid a case in which the terminal device continues to use or enable the second TCI state after activating the first TCI state, thereby reducing overall power consumption of the terminal device.

In the method shown in FIG. 5, the network device may update, based on an actual satellite movement trajectory and a coverage status, a satellite ephemeris list corresponding to a cell in which the terminal device is currently located, that is, support a serving cell in broadcasting ephemerides of a plurality of satellites based on a blocking status. In addition, the list may be updated in different time periods, that is, a same satellite identifier may correspond to different satellites and satellite ephemerides.

In other words, the terminal device may correspond to different TCI state sets at different times. The network device may indicate, to the terminal device, TCI state sets corresponding to different times. In addition, when a TCI state in the TCI state set needs to be activated, the network device may send, to the terminal device according to the foregoing method, information that indicates to activate a TCI state in the TCI state set. For specific descriptions, refer to the foregoing descriptions of the second information. Details are not described again.

If a satellite list corresponding to the cell in which the terminal device is currently located does not change, the terminal device may derive, based on a satellite ephemeris validity period corresponding to a satellite identifier obtained most recently, different locations corresponding to a same satellite at different moments. When a satellite changes, the terminal device needs to re-obtain a new ephemeris list in a manner in which a system message is updated. In this way, the network device can accurately indicate the terminal device to activate a TCI state in the TCI state set, so that the terminal device is supported in accessing a new satellite network.

The following describes apparatus embodiments corresponding to the method embodiments of this disclosure. The following merely briefly describes apparatuses. For specific implementation steps and details of the solutions, refer to the foregoing method embodiments.

To implement the functions in the method provided in this disclosure, both a terminal device and a network device may include hardware structures and/or software modules, and implement the foregoing functions in a form of a hardware structure, a software module, or a combination of a hardware structure and a software module. Whether a function in the foregoing functions is performed by using the hardware structure, the software module, or the combination of the hardware structure and the software module depends on particular applications and design constraint conditions of the technical solutions.

FIG. 6 is a block diagram of a communication apparatus according to an embodiment of this disclosure. The communication apparatus includes a processor 610 and a communication interface 620. The processor 610 and the communication interface 620 may be connected to each other through a bus 630. The communication apparatus may be a terminal device or a network device.

Optionally, the communication apparatus may further include a memory 640. The memory 640 includes but is not limited to a random access memory (RAM), a read-only memory (ROM), an erasable programmable read-only memory (EPROM), or a compact disc read-only memory (CD-ROM). The memory 640 is used for related instructions and data.

The processor 610 may be one or more central processing units (CPUs). When the processor 610 is one CPU, the CPU may be a single-core CPU or a multi-core CPU.

The processor 610 may be a signal processor, a chip, or another integrated circuit that can implement the method in this disclosure, or a part of a circuit that is in the foregoing processor, chip, or integrated circuit and that is configured to perform a processing function. In addition, the communication interface 620 may alternatively be an input/output interface, and the input/output interface is configured to input or output a signal or data; or may be an input/output circuit.

When the communication apparatus is the terminal device, for example, the processor 610 is configured to perform the following operations: receiving first information; determining, based on the first information, satellite information corresponding to a target area; and the like.

When the communication apparatus is the network device, for example, the processor 610 is configured to perform the following operations: determining first information, sending the first information, and the like.

The content described above is merely used as an example for description. When the communication apparatus is the terminal device or the network device, the communication apparatus is responsible for performing the methods or steps related to the terminal device or the network device in the foregoing method embodiments.

When the communication apparatus is the terminal device or the network device, the communication interface 620 may also be referred to as a transceiver. The foregoing descriptions are merely examples for description. For specific content, refer to the content described in the method embodiments.

For an implementation of each operation in FIG. 6, refer to corresponding descriptions in the method embodiments shown in FIG. 3 to FIG. 5.

FIG. 7 is a block diagram of another communication apparatus according to an embodiment of this disclosure. The communication apparatus may be a terminal device or a network device, or may be a chip or a module in the terminal device or the network device, and is configured to implement the method in the foregoing embodiments. The communication apparatus includes an interface unit 710 and a processing unit 720. The following describes the interface unit 710 and the processing unit 720 by using examples.

The interface unit 710 may include a sending unit and a receiving unit. The sending unit is configured to perform a sending action of the communication apparatus, and the receiving unit is configured to perform a receiving action of the communication apparatus. For ease of description, in this embodiment of this disclosure, the sending unit and the receiving unit are combined into one interface unit. Unified descriptions are provided herein, and details are not described below again.

When the communication apparatus is the terminal device, for example, the interface unit 710 is configured to receive first information and the like. The processing unit 720 is configured to perform steps related to processing, coordination, and the like, performed by the terminal device. For example, satellite information corresponding to a target area is determined based on the first information.

When the communication apparatus is the network device, for example, the interface unit 710 is configured to send first information and the like. The processing unit 720 is configured to perform steps related to processing, coordination, and the like, performed by the network device, for example, determining the first information.

The content described above is merely used as an example for description. When the communication apparatus is the terminal device or the network device, the communication apparatus is responsible for performing the methods or steps related to the terminal device or the network device in the foregoing method embodiments.

Optionally, the communication apparatus further includes a storage unit 730, and the storage unit 730 is configured to store a program or code used for performing the foregoing method.

The apparatus embodiments shown in FIG. 6 and FIG. 7 are used for implementing the content described in FIG. 3 to FIG. 5. For specific execution steps and methods of the apparatuses shown in FIG. 6 and FIG. 7, refer to the content described in the foregoing method embodiments.

This disclosure further provides a chip, including a processor, configured to invoke instructions from a memory and run the instructions stored in the memory, to cause a communication device on which the chip is installed to perform the method in the foregoing examples.

This disclosure further provides another chip, including an input interface, an output interface, and a processor. The input interface, the output interface, and the processor are connected to each other through an internal connection path. The processor is configured to execute code in a memory. When the code is executed, the processor is configured to perform the method in the foregoing examples. Optionally, the chip further includes the memory. The memory is configured to store a computer program or the code.

This disclosure further provides a processor, configured to be coupled to a memory, and configured to perform a method and a function related to the network device or the terminal device in any one of the foregoing embodiments.

Another embodiment of this disclosure provides a computer program product including instructions. When the computer program product runs on a computer, the method in the foregoing embodiments is implemented.

This disclosure further provides a computer program. When the computer program runs on a computer, the method in the foregoing embodiments is implemented.

Another embodiment of this disclosure provides a computer-readable storage medium. The computer-readable storage medium stores a computer program. When the computer program is executed by a computer, the method in the foregoing embodiments is implemented.

A person of ordinary skill in the art may be aware that, the units and algorithm steps described with reference to the examples in embodiments disclosed in this specification can be implemented by electronic hardware or a combination of computer software and electronic hardware. Whether the functions are performed by hardware or software depends on particular applications and design constraint conditions of the technical solutions. A person skilled in the art may use different methods to implement the described functions for each particular application, but it should not be considered that the implementation goes beyond the scope of this disclosure.

It may be clearly understood by a person skilled in the art that, for the purpose of convenient and brief description, for a detailed working process of the foregoing system, apparatus, and unit, refer to a corresponding process in the foregoing method embodiments. Details are not described herein again.

In several embodiments provided in this disclosure, the disclosed systems, apparatuses, and methods may be implemented in another manner. For example, the apparatus embodiments described above are merely examples. For example, division into the units is merely logical function division and may be other division in actual implementation. For example, a plurality of units or components may be combined or integrated into another system, or some features may be ignored or not performed. In addition, the displayed or discussed mutual couplings or direct couplings or communication connections may be implemented by using some interfaces. The indirect couplings or communication connections between the apparatuses or units may be implemented in electrical, mechanical, or another form.

The units described as separate parts may or may not be physically separate, and parts displayed as units may or may not be physical units, that is, may be located at one position, or may be distributed on a plurality of network units. Some or all of the units may be selected based on an actual requirement to achieve the objectives of the technical solutions of embodiments.

In addition, functional units in embodiments of this disclosure may be integrated into one processing unit, or each unit may exist alone physically, or two or more units may be integrated into one unit.

When functions are implemented in a form of a software functional unit and sold or used as an independent product, the functions may be stored in a computer-readable storage medium. Based on such an understanding, the technical solutions of embodiments of this disclosure essentially, or the part contributing to the conventional technology, or some of the technical solutions may be implemented in a form of a software product. The computer software product is stored in a storage medium, and includes several instructions for instructing a computer device (which may be a personal computer, a server, a network device, or the like) to perform all or some steps of the methods according to embodiments of this disclosure. The foregoing storage medium includes any medium that can store program code, such as a USB flash drive, a removable hard disk, a ROM, a RAM, a magnetic disk, or an optical disc.

The foregoing descriptions are merely specific implementations of embodiments of this disclosure, but are not intended to limit the protection scope of embodiments of this disclosure. Any variation or replacement readily figured out by a person skilled in the art within the technical scope disclosed in embodiments of this disclosure shall fall within the protection scope of embodiments of this disclosure. Therefore, the protection scope of embodiments of this disclosure should be subject to the protection scope of the claims.

1. A communication method, wherein the method is applied to a terminal device or a module of the terminal device, and the method comprises:
receiving first information, wherein the first information indicates satellite information of at least two areas, and the at least two areas comprise a target area of the terminal device; and
determining satellite information of the target area based on the first information.

2. The communication method according to claim 1, wherein the method further comprises:
performing satellite communication based on the satellite information of the target area.

3. The communication method according to claim 1, wherein the at least two areas comprise one or more of a first area, a second area, and a third area, wherein
the first area is an area in which a satellite service is always receivable by the terminal device;
the second area is an area in which a satellite service is receivable by the terminal device within a first time span; and
the third area is an area in which a satellite service is not receivable by the terminal device.

4. The communication method according to claim 1, wherein the satellite information comprises at least one of the following:
identifier information of a satellite, ephemeris information of the satellite, service time of the satellite, visibility time of the satellite, a coverage area of the satellite, or identifier information of an associated area.

5. The communication method according to claim 1, wherein the method further comprises:
receiving second information, wherein the second information indicates to activate a first transmission configuration indicator state in a transmission configuration indicator state set, each transmission configuration indicator state in the transmission configuration indicator state set is associated with one piece of satellite information, and the first transmission configuration indicator state is associated with the target area; and
activating the first transmission configuration indicator state based on the second information.

6. The communication method according to claim 5, wherein the method further comprises:
performing uplink synchronization based on satellite information associated with the first transmission configuration indicator state.

7. The communication method according to claim 5, wherein the second information comprises at least one of the following:
identifier information of the first transmission configuration indicator state, identifier information of the satellite information associated with the first transmission configuration indicator state, or identifier information of a satellite corresponding to the first transmission configuration indicator state.

8. A terminal device or a module of the terminal device, comprising:
at least one processor coupled to one or more memories storing programming instructions that, when executed by the at least one processor, cause the terminal device or the module of the terminal device to:
receive first information, wherein the first information indicates satellite information of at least two areas, and the at least two areas comprise a target area of the terminal device; and
determine satellite information of the target area based on the first information.

9. The terminal device or the module of the terminal device according to claim 8, wherein the programming instructions, when executed by the at least one processor, further cause the terminal device or the module of the terminal device to:
perform satellite communication based on the satellite information of the target area.

10. The terminal device or the module of the terminal device according to claim 8, wherein the at least two areas comprise one or more of a first area, a second area, and a third area, wherein
the first area is an area in which a satellite service is always receivable by the terminal device;
the second area is an area in which a satellite service is receivable by the terminal device within a first time span; and
the third area is an area in which a satellite service is not receivable by the terminal device.

11. The terminal device or the module of the terminal device according to claim 8, wherein the satellite information comprises at least one of the following:
identifier information of a satellite, ephemeris information of the satellite, service time of the satellite, visibility time of the satellite, a coverage area of the satellite, or identifier information of an associated area.

12. The terminal device or the module of the terminal device according to claim 8, wherein the programming instructions, when executed by the at least one processor, further cause the terminal device or the module of the terminal device to:
receive second information, wherein the second information indicates to activate a first transmission configuration indicator state in a transmission configuration indicator state set, each transmission configuration indicator state in the transmission configuration indicator state set is associated with one piece of satellite information, and the first transmission configuration indicator state is associated with the target area; and
activate the first transmission configuration indicator state based on the second information.

13. The terminal device or the module of the terminal device according to claim 12, wherein the programming instructions, when executed by the at least one processor, further cause the terminal device or the module of the terminal device to:
perform uplink synchronization based on satellite information associated with the first transmission configuration indicator state.

14. The terminal device or the module of the terminal device according to claim 12, wherein the second information comprises at least one of the following:
identifier information of the first transmission configuration indicator state, identifier information of the satellite information associated with the first transmission configuration indicator state, or identifier information of a satellite corresponding to the first transmission configuration indicator state.

15. A non-transitory computer-readable storage medium storing computer instructions that, when executed by a terminal device or a module of the terminal device, cause the terminal device or the module of the terminal device to:
receive first information, wherein the first information indicates satellite information of at least two areas, and the at least two areas comprise a target area of the terminal device; and
determine satellite information of the target area based on the first information.

16. The non-transitory computer-readable storage medium according to claim 15, wherein the computer instructions, when executed by the terminal device or the module of the terminal device, further cause the terminal device or the module of the terminal device to:
perform satellite communication based on the satellite information of the target area.

17. The non-transitory computer-readable storage medium according to claim 15, wherein the at least two areas comprise one or more of a first area, a second area, and a third area, wherein
the first area is an area in which a satellite service is always receivable by the terminal device;
the second area is an area in which a satellite service is receivable by the terminal device within a first time span; and
the third area is an area in which a satellite service is not receivable by the terminal device.

18. The non-transitory computer-readable storage medium according to claim 15, wherein the satellite information comprises at least one of the following:
identifier information of a satellite, ephemeris information of the satellite, service time of the satellite, visibility time of the satellite, a coverage area of the satellite, or identifier information of an associated area.

19. The non-transitory computer-readable storage medium according to claim 15, wherein the computer instructions, when executed by the terminal device or the module of the terminal device, further cause the terminal device or the module of the terminal device to:
receive second information, wherein the second information indicates to activate a first transmission configuration indicator state in a transmission configuration indicator state set, each transmission configuration indicator state in the transmission configuration indicator state set is associated with one piece of satellite information, and the first transmission configuration indicator state is associated with the target area; and
activate the first transmission configuration indicator state based on the second information.

20. The non-transitory computer-readable storage medium according to claim 19, wherein the computer instructions, when executed by the terminal device or the module of the terminal device, further cause the terminal device or the module of the terminal device to:
perform uplink synchronization based on satellite information associated with the first transmission configuration indicator state.
